(19) United States
(12) Patent Application Publication
(10) Pub. No.: US 2025/0185030 A1
(43) Pub. Date: Jun. 5, 2025

(54) RESOURCE SELECTION FOR SIDELINK COMMUNICATION

(71) Applicant: Nokia Technologies Oy, Espoo (FI)

(72) Inventors: Yong LIU, Shanghai (CN); Daniel MEDINA, Munich (DE); Renato Barbosa ABREU, Aalborg (DK); Nuno Manuel KIILERICH PRATAS, Gistrup (DK); Thomas Haaning JACOBSEN, Nørresundby (DK); Torsten WILDSCHEK, Gloucestershire (GB)

(21) Appl. No.: 18/842,876

(22) PCT Filed: Jul. 27, 2022
(86) PCT No.: PCT/CN2022/108384

§ 371 Date: Aug. 30, 2024

(51) Int. Cl. H04W 72/25; H04B 7/06; H04L 5/00

(52) U.S. Cl. CPC H04W 72/25; H04B 7/06954; H04L 5/0023; H04L 5/0055

(57) ABSTRACT

Embodiments of the present disclosure relate to resource selection for sidelink communication. According to one aspect of the present disclosure, a first transmitting device determines information of a first resource to be used by a receiving device for transmission of a first feedback to the first transmitting device, and transmits the information of the first resource to a second transmitting device. The second transmitting device determines a third resource reserved for a second data transmission from the second transmitting device to the receiving device such that a fourth resource associated with the third resource does not conflict with the first resource. In this way, resource selection for sidelink communication with sidelink beam management may be enhanced.

### FIELD

Various example embodiments relate to the field of telecommunication and in particular, to a method, device, apparatus and computer readable storage medium of resource selection for sidelink communication.

### BACKGROUND

As known, a physical sidelink feedback channel (PSFCH) for sidelink communication is specified to carry hybrid automatic repeat request (HARQ) feedback over a sidelink from a device which is an intended recipient of a physical sidelink control channel (PSCCH)/physical sidelink shared channel (PSSCH) transmission (also referred to as a receiving device herein) to a device which performed the PSCCH/PSSCH transmission (also referred to as a transmitting device herein). However, in some cases two transmitting devices are in sidelink communication with a same receiving device, a problem may arise when feedback from the receiving device is transmitted to respective transmitting devices using directional transmissions. Thus, enhanced resource selection for sidelink communication with sidelink beam management needs to be developed.

### SUMMARY

In general, example embodiments of the present disclosure provide a solution of resource selection for sidelink communication with sidelink beam management.

In a first aspect, there is provided a first transmitting device. The first transmitting device comprises at least one processor; and at least one memory storing instructions that, when executed by the at least one processor, cause the first transmitting device at least to: determine information of a first resource to be used by a receiving device for transmission of a first feedback to the first transmitting device, the first feedback being for a first data transmission from the first transmitting device to the receiving device; and transmit the information of the first resource to a second transmitting device.

In a second aspect, there is provided a second transmitting device. The second transmitting device comprises at least one processor; and at least one memory storing instructions that, when executed by the at least one processor, cause the second transmitting device at least to: receive information of a first resource to be used by a receiving device for transmission of a first feedback to a first transmitting device, the first feedback being for a first data transmission from the first transmitting device to the receiving device; and determine a third resource reserved for a second data transmission from the second transmitting device to the receiving device such that a fourth resource associated with the third resource does not conflict with the first resource, the fourth resource being used by the receiving device for transmission of a second feedback to the second transmitting device, the second feedback being for the second data transmission.

In a third aspect, there is provided a method for communication. The method comprises: determining, at a first transmitting device, information of a first resource to be used by a receiving device for transmission of a first feedback to the first transmitting device, the first feedback being for a first data transmission from the first transmitting device to the receiving device; and transmitting the information of the first resource to a second transmitting device.

In a fourth aspect, there is provided a method for communication. The method comprises: receiving, at a second transmitting device, information of a first resource to be used by a receiving device for transmission of a first feedback to a first transmitting device, the first feedback being for a first data transmission from the first transmitting device to the receiving device; and determining a third resource reserved for a second data transmission from the second transmitting device to the receiving device such that a fourth resource associated with the third resource does not conflict with the first resource, the fourth resource being used by the receiving device for transmission of a second feedback to the second transmitting device, the second feedback being for the second data transmission.

In a fifth aspect, there is provided an apparatus for communication. The apparatus comprises: means for determining, at a first transmitting device, information of a first resource to be used by a receiving device for transmission of a first feedback to the first transmitting device, the first feedback being for a first data transmission from the first transmitting device to the receiving device; and means for transmitting the information of the first resource to a second transmitting device.

In a sixth aspect, there is provided an apparatus for communication. The apparatus comprises: means for receiving, at a second transmitting device, information of a first resource to be used by a receiving device for transmission of a first feedback to a first transmitting device, the first feedback being for a first data transmission from the first transmitting device to the receiving device; and means for determining a third resource reserved for a second data transmission from the second transmitting device to the receiving device such that a fourth resource associated with the third resource does not conflict with the first resource, the fourth resource being used by the receiving device for transmission of a second feedback to the second transmitting device, the second feedback being for the second data transmission.

In a seventh aspect, there is provided a non-transitory computer readable medium comprising program instructions that, when executed by an apparatus, cause the apparatus to perform at least the method according to the third or fourth aspect.

In an eighth aspect, there is provided a computer program comprising instructions, which, when executed by an apparatus, cause the apparatus to perform at least the method according to the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which embodiments of the present disclosure may be implemented;

FIG. 2 illustrates a diagram illustrating an example sidelink slot configuration in which embodiments of the present disclosure may be implemented:

FIG. 3A illustrates a diagram illustrating an example Uu initial beam alignment procedure:

FIG. 3B illustrates a diagram illustrating an example sidelink initial beam alignment procedure;

FIG. 4A illustrates a diagram illustrating an example scenario in sidelink transmission:

FIG. 4B illustrates a diagram illustrating an example of a resource conflict as a result of directional PSFCH transmission:

FIG. 5 illustrates a flowchart illustrating a process of resource selection for sidelink communication with sidelink beam management according to some embodiments of the present disclosure;

FIG. 6A illustrates a diagram of resource selection for sidelink communication according to some embodiments of the present disclosure:

FIG. 6B illustrates a diagram of resource reselection for sidelink communication according to some embodiments of the present disclosure:

FIG. 7 illustrates a flowchart of an example method implemented at a first transmitting device according to some embodiments of the present disclosure:

FIG. 8 illustrates a flowchart of an example method implemented at a second transmitting device according to some embodiments of the present disclosure:

FIG. 9 illustrates a simplified block diagram of a device that is suitable for implementing embodiments of the present disclosure; and

FIG. 10 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR next generation NodeB (also referred to as a gNB), a Remote Radio Unit (RRU), a radio header (RH), a remote radio head (RRH), a relay, a low power node such as a femto, a pico, and so forth, depending on the applied terminology and technology. An RAN split architecture comprises a gNB-CU (Centralized unit, hosting RRC, SDAP and PDCP) controlling a plurality of gNB-DUs (Distributed unit, hosting RLC, MAC and PHY).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

It has been proposed to study and specify an enhanced sidelink operation on a frequency range 2 (FR2) licensed spectrum in the following aspects: update evaluation methodology for commercial deployment scenario: work is limited to the support of sidelink beam management (including initial beam-pairing, beam maintenance, and beam failure recovery, etc.) by reusing existing sidelink channel state information (CSI) framework and reusing Uu beam management concepts wherever possible. Beam management in FR2 licensed spectrum considers sidelink unicast communication only.

Embodiments of the present disclosure provide a solution of resource selection for sidelink communication with sidelink beam management. In the solution, a transmitting device determines information of a resource (for convenience, also referred to as a first resource herein) to be used by a receiving device for transmission of a feedback to the transmitting device, and transmits the information of the first resource to another transmitting device. Based on the information of the first resource, the other transmitting device performs resource selection or reselection such that a resource (for convenience, also referred to as a fourth resource herein) to be used by the receiving device for transmission of a feedback to the other transmitting device does not conflict with the first resource.

The present solution is beneficial whenever a feedback is transmitted directionally by terminal devices that are not capable of transmitting simultaneously on multiple antenna panels or beams. By selecting resources for PSCCH/PSSCH transmission in such a way that simultaneous PSFCH transmission on multiple antenna panels or beams is avoided, fewer PSFCH transmissions may need to be dropped. Thus, link-level and system-level performance may be enhanced.

Principles and implementations of the present disclosure will be described in detail below with reference to the figures.

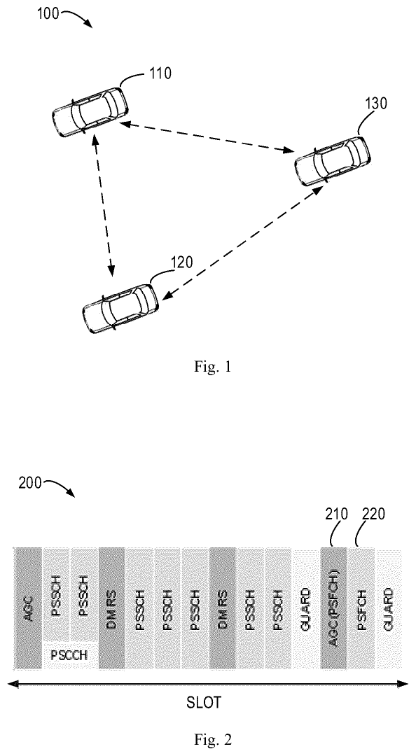

FIG. 1 illustrates a schematic diagram of an example communication environment 100 in which embodiments of the present disclosure can be implemented. As shown in FIG. 1, the communication environment 100 may involve a plurality of devices such as devices 110, 120 and 130.

In this example, the devices 110, 120 and 130 are illustrated as vehicles. It should be noted that any of the devices 110, 120 and 130 may be any other suitable types of terminal devices or network devices, such as mobile phones, sensors and so on. Further, it is to be understood that the number of devices is only for the purpose of illustration without suggesting any limitations. The communication environment 100 may include any suitable number or type of devices adapted for implementing embodiments of the present disclosure.

In addition, the communication environment 100 may further include one or more devices (not shown) serving one or more of the devices 110, 120 and 130. For example, the one or more devices may communicate with any of the devices 110, 120 and 130 via an air interface such as Uu interface or the like.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G) or the future sixth generation (6G) wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Any two of the devices 110, 120 and 130 may communicate with each other via a sidelink interface. For example, any two of the devices 110, 120 and 130 may communicate with each other via a sidelink data channel such as a PSSCH, a sidelink control channel such as a PSCCH or a PSFCH, or any other existing or future sidelink channels.

In some scenarios, the device 110 may transmit a data transmission (for example, a PSCCH/PSSCH transmission) to the device 130 and the device 130 may transmit a HARQ feedback (e.g., a PSFCH transmission) for the data transmission to the device 110. The device 120 may transmit another data transmission (for example, another PSCCH/PSSCH transmission) to the device 130 and the device 130 may transmit a HARQ feedback (e.g., another PSFCH transmission) for the other data transmission to the device 110.

FIG. 2 illustrates a diagram 200 illustrating an example sidelink slot configuration in which embodiments of the present disclosure may be implemented. A slot format of PSCCH, PSSCH, and PSFCH is provided in FIG. 2. As shown in FIG. 2, a PSFCH may transmit a sequence in one physical resource block (PRB) repeated over two OFDM symbols 210 and 220 near the end of the slot. The OFDM symbol 210 (i.e., the first one of the two OFDM symbols) may be used for automatic gain control (AGC). The sequence may be configured or pre-configured per sidelink resource pool.

In some embodiments, resources for PSFCH may be configured or pre-configured to occur once in every 1, 2, or 4 slots. A resource location for the HARQ feedback (PSFCH) may be derived from a resource location of a PSCCH/PSSCH transmission.

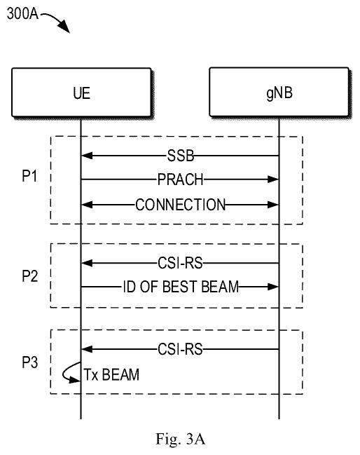

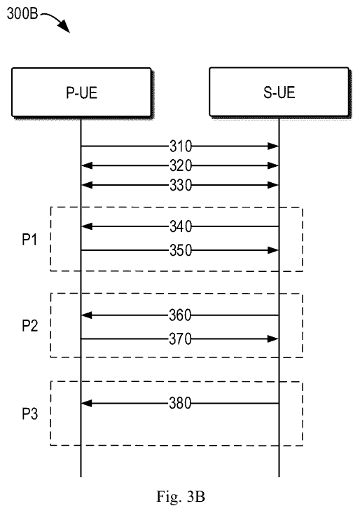

FIG. 3A illustrates a diagram illustrating an example Uu initial beam alignment procedure 300A. The procedure 300A may comprise three phases as below.
Phase #1 (P1): UE uses a broad receive (Rx) beam while gNB is performing synchronization signal (SS) burst where synchronization signal and physical broadcast channel blocks (SSBs) are swept and transmitted in different angular directions covering the cell. UE measures reference signal receiving power (RSRP) for all SSB beams on all UE panels and sends physical random access channel (PRACH) on a random access channel (RACH) occasion associated to the best SSB beam to connect to a network with the reciprocal transmit (Tx) beam of the best SSB beam.
Phase #2 (P2): UE uses a broad Rx beam to receive gNB refined downlink (DL) channel state information-reference signal (CSI-RS) beam sweeping within the connected SSB beam. UE measures RSRP for all CSI-RS beams and reports one or more identities (IDs) of the best beam back to gNB still using the reciprocal broad Tx beam.
Phase #3 (P3): gNB transmits a repeated CSI-RS with the selected beam based on UE reporting in Phase #2 and UE sweeps refined Rx beam settings to identify its best narrow Rx beam.

At the end of P3, alignment between gNB Tx beam and UE Rx beam is obtained for maximized directional gain.

Accordingly, a sidelink operation in FR2 will be a CSI-RS based procedure and attempt to reuse as much as possible of the Uu beam alignment procedure. FIG. 3B illustrates a diagram illustrating an example sidelink initial beam alignment procedure 300B. The procedure 300B is inspired from the Uu initial beam alignment procedure 300A.

As shown in FIG. 3B, at step 310, a discovery procedure may be performed, e.g., following proximity services (Prose) and discovery model A or B. For the case of V2x, the discovery procedure occurs at a V2x layer and is enabled by exchange of cooperative awareness messages (CAMs) in an intelligent transportation system (ITS) band at 5.9 GHZ.

The discovery procedure may occur in either FR1 or FR2. However, the benefit of doing this in FR1 is the absence of the need to perform beam-based discovery. If applied at FR2 then the discovery procedure will need to be performed with only wide beams, so the discovery procedure may be limited in coverage and take a long time for devices only capable of transmitting from a single panel at the time.

At step 320, primary UE (P-UE) and secondary UE (S-UE) establishes a unicast link via PC5 connection establishment. This may either be performed at FR1 or FR2.

At step 330, the P-UE or S-UE triggers an initial beam alignment. This trigger may occur at either FR1 or FR2, and may indicate configuration details on the beam alignment (e.g. sidelink beam management reference signals (SL-BMRS) format to be used, number of expected beam sweeps, the time period where the beam sweeps are expected etc.).

At step 340, the P-UE performs the wide SL-BMRS beam sweep. This step is dedicated to FR2. The slot format used to transmit these SL-BMRS for the purpose of beam sweeping is still open. However, for the present solution, we may assume that each individual SL-BMRS is transmitted in a single SL slot. Therefore, if four wide beam sweeps are required, then the P-UE will have to transmit 4 distinct SL slots, each with a different beam applied.

At step 350, the S-UE reports to the P-UE what was the best wide SL-BMRS beam (e.g. the index or slot of the SL-BMRS beam received with the highest power). This report may be transmitted in FR1 or FR2. This corresponds to the completion of P1.

At step 360, the P-UE performs the narrow SL-BMRS beam sweep. This step is dedicated to FR2. As in step 340, here it is assumed that this sweep will utilize a single SL slot per beam sweep.

At step 370, the S-UE reports to the P-UE what was the best narrow SL-BMRS beam. This report may be transmitted in FR1 or FR2. This corresponds to the completion of P2.

At step 380, the P-UE performs m repetitions of the SL-BMRS while applying the selected narrow Tx beam. The S-UE performs a narrow Rx beam sweep with the purpose of identifying the best narrow Rx beam. This corresponds to the completion of P3.

So far, alignment between P-UE Tx beam and S-UE Rx beam may be obtained for maximized directional gain.

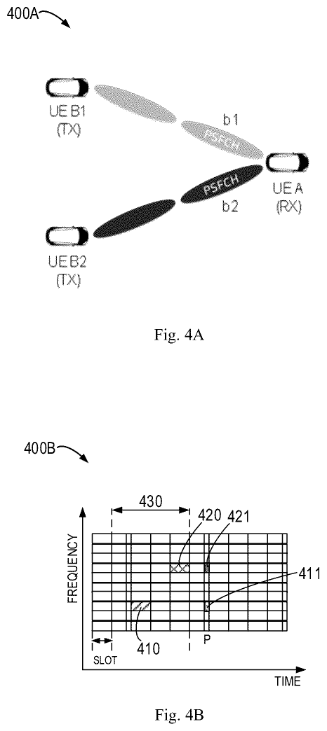

In some scenarios, two transmitting devices may be in sidelink communication with the same receiving device. In this case, an issue may arise when feedback from the receiving device is transmitted to the respective transmitting devices using directional transmission (i.e., not omni-directionally). This will be described in details with reference to FIGS. 4A and 4B below.

FIG. 4A illustrates a diagram 400A illustrating an example scenario in sidelink transmission. As shown, a receiving device (UE A) may transmit a PSFCH (carrying HARQ feedback) to a first transmitting device (UE B1) on a first antenna panel or beam (b1) and transmit another PSFCH (carrying HARQ feedback) to a second transmitting device (UE B2) on a second antenna panel or beam (b2).

In some scenarios, both transmitting devices UE B1 and UE B2 select resources for transmission to the same receiving device UE A in such a way that a PSFCH occasion for transmission of feedback by the receiving device UE A to each of the transmitting devices UE B1 and UE B2 is the same. FIG. 4B illustrates a diagram 400B illustrating an example of a resource conflict as a result of directional PSFCH transmission. For convenience, this will be described in connection with the example of FIG. 4A.

As shown in FIG. 4B, the transmitting device UE B1 may select a resource 410 for PSCCH/PSSCH transmission to the receiving device UE A. Then a resource 411 associated with the resource 410 may be determined for transmission of a feedback by the receiving device UE A to the transmitting device UE B1. The transmitting device UE B2 may select a resource 420 for PSCCH/PSSCH transmission to the receiving device UE A. Then a resource 421 associated with the resource 420 may be determined for transmission of a feedback by the receiving device UE A to the transmitting device UE B2. It can be seen that the resources 411 and 421 correspond to the same PSFCH occasion P but different frequencies (e.g., different PRBs) and different beams/panels. In fact, all resources within a range 430 may be resources associated with the same PSFCH occasion P.

However, if the receiving device UE A employs analog beamforming to transmit PSFCH directionally, the UE A may only transmit on one beam at a time and may be not capable of transmitting simultaneously on multiple antenna panels or beams (b1, b2).

Conventionally, a straightforward but compromised way to address the above problem is to drop some of the PSFCH transmissions with conflicting antenna panels or beams. In this example, the receiving device UE A may need to drop one of the PSFCH transmissions (e.g., that which has lower priority). This may degrade system performance, e.g., reduce resource efficiency by introducing unnecessary HARQ retransmissions as a result of missing HARQ feedback and increase latency of data transmission.

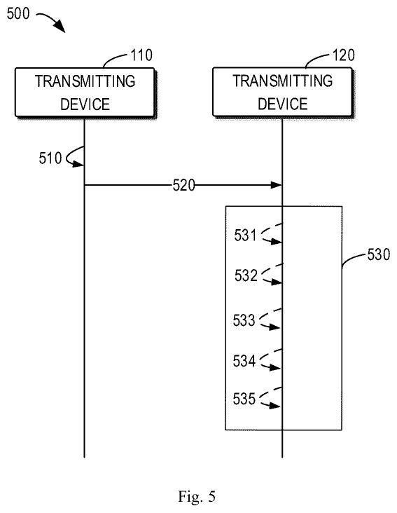

In view of this, embodiments of the present disclosure provide a solution of resource selection for sidelink communication with sidelink beam management to overcome the above and other potential issues. In the solution, information of a resource for feedback transmission is transmitted from a transmitting device to another transmitting device and the other transmitting device makes resource selection or reselection based on the information of the resource so as to avoid conflict of resources for feedback transmissions. More details will be described below in connection with FIG. 5.

FIG. 5 illustrates a flowchart illustrating a process 500 of resource selection for sidelink communication with sidelink beam management according to some embodiments of the present disclosure. For the purpose of discussion, the process 500 will be described with reference to FIG. 1. The process 500 may involve the devices 110, 120 and 130 as illustrated in FIG. 1. It is assumed that the devices 110 and 120 are transmitting devices and the device 130 is a receiving device. For convenience, the devices 110 and 120 may also be referred to as the transmitting devices 110 and 120, and the device 130 may also be referred to as the receiving device 130. It would be appreciated that although the process 500 has been described in the communication environment 100 of FIG. 1, this process may be likewise applied to other communication scenarios.

As shown in FIG. 5, the transmitting device 110 may determine 510 information of a resource (i.e., the first resource) to be used by the receiving device 130 for transmission of a feedback (for convenience, also referred to as a first feedback herein) to the transmitting device 110.

In some embodiments, when the transmitting device 110 is to perform a data transmission (for convenience, also referred to as a first data transmission herein) to the receiving device 130, the transmitting device 110 may perform a resource selection to determine a resource (for convenience, also referred to as a second resource herein) for the data transmission. It is to be noted that the resource selection may be carried out in any suitable ways existing or to be future developed, and the present disclosure does not limit this aspect.

In some embodiments, the first data transmission may be a PSSCH transmission. In some embodiments, the first data transmission may be a PSCCH/PSSCH transmission. In some embodiments, the first feedback may comprise a positive acknowledgement (ACK) for the first data transmission. In some embodiments, the first feedback may comprise a negative acknowledgement (NACK) for the first data transmission.

Based on the determined second resource for the first data transmission, the transmitting device 110 may derive the first resource (e.g., PSFCH resource) to be used by the receiving device 130 for transmission of the first feedback to the transmitting device 110. The first resource is associated with the second resource. In some embodiments, the first resource may be separated from the second resource by a predetermined number of slots. In some embodiments, the first resource may be later than the second resource by the predetermined number slots. It is to be understood that any other suitable associations between the first and second resources are also feasible and the present disclosure does not limit this aspect.

Then the transmitting device 110 may determine information of the first resource. In some embodiments, the information of the first resource may comprise time domain information. For example, the time domain information may comprise time domain information of a PSFCH, e.g., an index of a slot. In some embodiments, the information of the first resource may comprise frequency domain information. For example, the frequency domain information may comprise frequency domain information of the PSFCH, e.g., a PRB index.

In some embodiments, the information of the first resource may comprise spatial domain information. For example, the spatial domain information may comprise information of a beam used for the transmission of the first feedback. In another example, the spatial domain information may comprise information of an antenna panel or a panel used for the transmission of the first feedback.

In some embodiments, the spatial domain information may be determined based on the procedure 300B or any other suitable ways. In some embodiments, the receiving device 130 may need to perform Tx beam sweeping to find the best beam (e.g., first antenna panel or beam (b1)) for PSFCH transmission towards the transmitting device 110. The transmitting device 110 may assume that the receiving device 130 when transmitting PSFCH will use the best beam reported by the transmitting device 110. If both the transmitting device 110 and the transmitting device 120 go through the same Tx beam sweeping procedure with the receiving device 130, both the transmitting device 110 and the transmitting device 120 have the same understanding of beams.

In some embodiments, for a scenario with bi-directional data traffic, the receiving device 130 usually needs to broadcast the information of its Tx beam towards the transmitting device 110 in a form of absolute beam direction and beam bandwidth in sidelink control information (SCI) to assist resource selection at other third party devices. The same Tx beam is also used for a PSFCH transmission towards the transmitting device 110.

It is to be understood that the information of the first resource may comprise any combination of the above information and any other suitable information.

Continue to refer to FIG. 5, upon determination of the information of the first resource, the transmitting device 110 transmits 520 the information of the first resource to the transmitting device 120. In some embodiments, the transmitting device 110 may transmit the information of the first resource in sidelink control information (SCI) indicating the second resource reserved for the data transmission. For example, the transmitting device 110 may transmit an indication of the second resource reserved for the data transmission in a first stage of the SCI, and transmit the information of the first resource in a second stage of the SCI. It is to be understood that the second resource and the information of the first resource may also be indicated together by SCI.

Alternatively, the transmitting device 110 may transmit 520 information of a receiving panel or beam used by the receiving device 130 to receive the first data transmission from the transmitting device 110 and an indication of channel reciprocity to the transmitting device 120. In some embodiments, the transmitting device 110 may transmit the information of the receiving panel or beam and the indication of channel reciprocity in SCI indicating the second resource reserved for the data transmission. Based on channel reciprocity, the receiving panel or beam may indicate spatial domain of the first resource, i.e., a panel or beam same as the receiving panel or beam is to be used by the receiving device 130 for transmission of the first feedback to the transmitting device 110.

With reference to FIG. 5, upon reception of the information of the first resource, the transmitting device 120 determines 530 a resource (for convenience, also referred to as a third resource herein) reserved for a data transmission (for convenience, also referred to as a second data transmission herein) from the transmitting device 120 to the receiving device 130 such that a resource (for convenience, also referred to as a fourth resource herein) associated with the third resource does not conflict with the first resource. The fourth resource (e.g., PFSCH resource) is used by the receiving device 130 for transmission of a feedback (for convenience, also referred to as a second feedback herein) to the transmitting device 120.

In some embodiments, the second data transmission may be a PSSCH transmission. In some embodiments, the second data transmission may be a PSCCH/PSSCH transmission. In some embodiments, the second feedback may comprise ACK for the second data transmission. In some embodiments, the second feedback may comprise NACK for the second data transmission.

In some embodiments, the transmitting device 120 may determine the third resource by performing a resource selection. In some embodiments, the transmitting device 120 may determine the third resource by performing a resource reselection. The detailed description will be given below.

In some embodiments, when the transmitting device 120 receives the SCI comprising the information of the first resource, the transmitting device 120 may have not determined the third resource reserved for the second data transmission. In this case, the transmitting device 120 may perform a resource selection to determine the third resource.

With reference to FIG. 5, during the resource selection, the transmitting device 120 may determine 531, from a set of candidates for the third resource, a set of resources (for convenience, also referred to as a set of conflicting resources) associated with a set of fourth resources (e.g., PSFCH resources). The set of fourth resources conflict with (e.g. is/are different than) the first resource in spatial domain and overlap with (e.g. is/are same as) the first resource in time domain. For example, a slot associated with each resource in the set of fourth resources is the same as a slot associated with the first resource and a beam or panel for each resource in the set of fourth resources is different from a beam or panel for the first resource.

In some embodiments, the transmitting device 120 may determine fourth resources in slots associated with the first resource (e.g., a PSFCH occasion) as being in conflict with the first resource if a corresponding antenna panel or beam of the receiving device 130 to be used for feedback transmission to the transmitting device 120 differs from an antenna panel or beam of the receiving device 130 to be used for feedback transmission to the transmitting device 110.

Then the transmitting device 120 may determine 532 one in the set of candidates as the third resource by excluding or deprioritizing the set of conflicting resources from the set of candidates. The transmitting device 120 may thus choose, as the third resource used for the second data transmission from the second transmitting device 120 to the receiving device 130, a resource that is associated with such a fourth resource (used by the receiving device 130 for the second feedback from the receiving device 130 to the second transmitting device 110) that does not conflict with the first resource (used by the receiving device 130 for the first feedback from the receiving device 130 to the first transmitting device 110).

In this way, simultaneous PSFCH transmission on multiple antenna panels or beams may be avoided, and PSFCH transmissions to be dropped may be reduced. Thus, link-level and system-level performance may be enhanced.

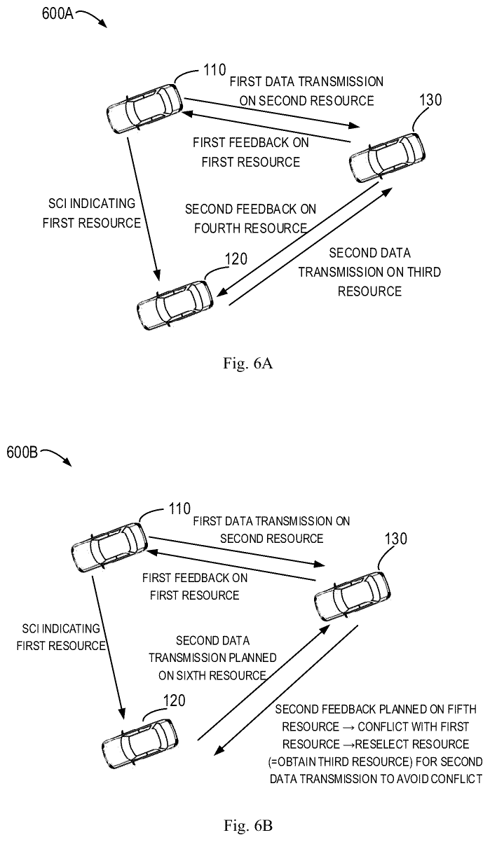

For illustration, an example procedure of resource selection may be described with reference to FIG. 6A. FIG. 6A illustrates a diagram 600A of resource selection for sidelink communication according to some embodiments of the present disclosure. As shown in FIG. 6A, the transmitting device 110 may transmit the first data transmission on the second resource to the receiving device 130. The receiving device 130 may transmit the first feedback on the first resource. The transmitting device 110 may transmit SCI indicating the first resource to the transmitting device 120. The transmitting device 120 may transmit the second data transmission on the third resource to the receiving device 130. The receiving device 130 may transmit the second feedback on the fourth resource to the transmitting device 120.

In some embodiments, when the transmitting device 120 receives the SCI comprising the information of the first resource, the transmitting device 120 may have selected a resource (for convenience, also referred to as a sixth resource herein) for the second data transmission but have not sent SCI indicating the selected resource reserved for the second data transmission. Correspondingly, a resource (for convenience, also referred to as a fifth resource herein) to be used for transmission of the second feedback has also been determined as the fifth resource associated with the selected resource.

In this case, continue to refer to FIG. 5, the transmitting device 120 may determine 533 whether the fifth resource conflicts with the first resource. In some embodiments, the transmitting device 120 may determine whether the fifth resource conflicts with the first resource in spatial domain and overlaps with the first resource in time domain. If the fifth resource conflicts with the first resource in spatial domain and overlaps with the first resource in time domain, the transmitting device 120 may determine that the fifth resource conflicts with the first resource.

For example, if a PSFCH occasion associated with the fifth resource is the same as a PSFCH occasion associated with the first resource and a beam or panel for the fifth resource is different from a beam or panel for the first resource, the transmitting device 120 may determine that the fifth resource conflicts with the first resource. That is, the transmitting device 120 may determine an expected/potential resource conflict between PSFCH transmissions to the transmitting devices 110 and 120. This may trigger resource reselection at the transmitting device 120 to prevent the conflict.

Continue to refer to FIG. 5, upon determination that the fifth resource conflicts with the first resource, the transmitting device 120 may perform 534 a resource reselection to determine the third resource reserved for the second data transmission such that a resource (e.g. fourth resource) to be used by the receiving device 130 for feedback transmission to the transmitting device 120 does not conflict with the first resource. During the resource reselection, the transmitting device 120 may perform a resource selection similar to that described in connection with the operations 531 and 532 to determine the third resource.

If the transmitting device 120 determines that the fifth resource does not conflict with the first resource, the transmitting device 120 may determine 535 the fifth resource as the third resource.

In this way, simultaneous PSFCH transmission on multiple antenna panels or beams may also be avoided, and PSFCH transmissions to be dropped may also be reduced. Corresponding link-level and system-level performance may be enhanced.

In some embodiments, when the transmitting device 120 receives the SCI comprising the information of the first resource, the transmitting device 120 may have already selected a resource for the second data transmission and have sent SCI indicating the selected resource reserved for the second data transmission. Correspondingly, a resource (i.e., the fifth resource) to be used for transmission of the second feedback has also been determined as the fifth resource associated with the selected resource. The transmitting device 120 may determine whether the fifth resource conflicts with the first resource. Upon determination that the fifth resource conflicts with the first resource and the priority of the second data transmission is lower than the priority of the first data transmission, the transmitting device 120 may perform a resource reselection to determine the third resource reserved for the second data transmission such that a resource (e.g. fourth resource) to be used by the receiving device 130 for feedback transmission to the transmitting device 120 does not conflict with the first resource.

It is to be noted that the process 500 as shown in FIG. 5 is merely an example, and may have additional or less operations.

For illustration, an example procedure of resource reselection may be described with reference to FIG. 6B. FIG. 6B illustrates a diagram 600B of resource reselection for sidelink communication according to some embodiments of the present disclosure. As shown in FIG. 6B, the transmitting device 110 may transmit the first data transmission on the second resource to the receiving device 130. The receiving device 130 may transmit the first feedback on the first resource. The transmitting device 110 may transmit SCI indicating the first resource to the transmitting device 120.

The transmitting device 120 has planned to transmit the second data transmission on the sixth resource and receive a second feedback on the fifth resource. Upon reception of the SCI, the transmitting device 120 knows the fifth resource conflicts with the first resource. Then the transmitting device 120 reselects a resource (i.e., the third resource) for the second data transmission so as to avoid the confliction with the first resource. The receiving device 130 may transmit the second feedback to the transmitting device 120 on the fourth resource associated with the reselected third resource.

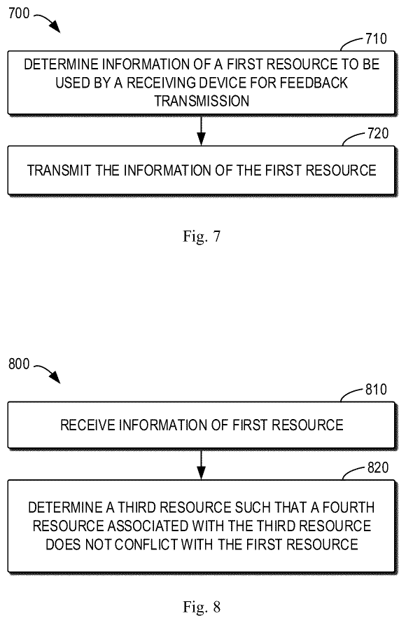

Corresponding to the above process, example embodiments of the present disclosure also provide methods of communication. FIG. 7 illustrates a flowchart of an example method 700 implemented at a first transmitting device according to some embodiments of the present disclosure. For the purpose of discussion, the method 700 will be described with reference to FIG. 1. It is assumed that the transmitting devices 110 and 120 are in sidelink communication with the same receiving device 130. The method 600 may be carried out at the transmitting devices 110 or 120. For convenience, the following description is given by taking the transmitting device 110 as an example of a first transmitting device.

At block 710, the transmitting device 110 determines information of a first resource to be used by the receiving device 130 for transmission of a first feedback to the transmitting device 110. The first feedback is for a first data transmission from the transmitting device 110 to the receiving device 130. In some embodiments, the first feedback may comprise ACK or NACK for the first data transmission. In some embodiments, the first data transmission may comprise a PSSCH transmission. In some embodiments, the first data transmission may comprise a PSCCH/PSSCH transmission.

In some embodiments, the information of the first resource may comprise at least one of the following: time domain information, frequency domain information, or spatial domain information. In some embodiments, the spatial domain information may comprise at least one of the following: information of a beam used for the transmission of the first feedback, or information of a panel used for the transmission of the first feedback. In this way, a beam direction aware sidelink resource selection may be facilitated.

At block 720, the transmitting device 110 transmits the information of the first resource to a second transmitting device (e.g., the transmitting device 120). In some embodiments, the transmitting device 110 may transmit the information of the first resource to the transmitting device 120 in SCI indicating a second resource reserved for the first data transmission. In this way, signaling overhead for transmission of the information of the first resource may be minimized.

In some embodiments, the transmitting device 110 may transmit an indication of the second resource reserved for the first data transmission in a first stage of the SCI, and transmit the information of the first resource in a second stage of the SCI. In this way, transmission of an indication of the second resource and the information of the first resource may be optimized.

With the method 700, PFSCH resource information for a transmitting device may be transmitted to another transmitting device for use in resource selection or reselection at the other transmitting device to prevent conflict of PFSCH resources.

FIG. 8 illustrates a flowchart of an example method 800 implemented at a second transmitting device according to some embodiments of the present disclosure. For the purpose of discussion, the method 800 will be described with reference to FIG. 1. It is assumed that the transmitting devices 110 and 120 are in sidelink communication with the same receiving device 130. The method 800 may be carried out at the transmitting devices 110 or 120. For convenience, the following description is given by taking the transmitting device 120 as an example of a second transmitting device.

At block 810, a second transmitting device (e.g., the transmitting device 120) receives information of a first resource to be used by a receiving device (e.g., the receiving device 130) for transmission of a first feedback to a first transmitting device (e.g., the transmitting device 110). The first feedback is for a first data transmission from the transmitting device 110 to the receiving device 130.

In some embodiments, the first feedback may comprise ACK or NACK for the first data transmission. In some embodiments, the first data transmission may comprise a PSSCH transmission. In some embodiments, the first data transmission may comprise a PSCCH/PSSCH transmission.

In some embodiments, the information of the first resource may comprise at least one of the following: time domain information, frequency domain information, or spatial domain information. In some embodiments, the spatial domain information may comprise at least one of the following: information of a beam used for the transmission of the first feedback, or information of a panel used for the transmission of the first feedback. In this way, a beam direction aware sidelink resource selection may be facilitated.

In some embodiments, the transmitting device 120 may receive the information of the first resource in SCI indicating a second resource reserved for the first data transmission. In this way, signaling overhead for transmission of the information of the first resource may be minimized.

In some embodiments, the transmitting device 120 may receive an indication of the second resource reserved for the first data transmission in a first stage of the SCI, and receive the information of the first resource in a second stage of the SCI. In this way, transmission of an indication of the second resource and the information of the first resource may be optimized.

At block 820, the transmitting device 120 determines a third resource reserved for a second data transmission from the transmitting device 120 to the receiving device 130 such that a fourth resource associated with the third resource does not conflict with the first resource. The fourth resource is used by the receiving device 130 for transmission of a second feedback to the transmitting device 120. The second feedback is for the second data transmission.

In some embodiments, the second feedback may comprise ACK or NACK for the second data transmission. In some embodiments, the second data transmission may comprise a PSSCH transmission. In some embodiments, the second data transmission may comprise a PSCCH/PSSCH transmission.

In some embodiments, the transmitting device 120 may has determined a sixth resource for the second data transmission and a fifth resource for the second feedback is associated with the sixth resource. Upon reception of the information of the first resource, the transmitting device 120 may determine whether the fifth resource conflicts with the first resource.

In some embodiments, the transmitting device 120 may determine whether the fifth resource conflicts with the first resource in spatial domain and overlaps with the first resource in time domain. If the fifth resource conflicts with the first resource in spatial domain and overlaps with the first resource in time domain, the transmitting device 120 may determine that the fifth resource conflicts with the first resource.

If the fifth resource does not conflict with the first resource, the transmitting device 120 may determine the fifth resource as the third resource. If the fifth resource conflicts with the first resource, the transmitting device 120 may reselect a resource, as the third resource, for the second data transmission. In this way, a beam direction aware sidelink resource reselection may be achieved.

In some embodiments, the transmitting device 120 may determine, from a set of candidates for the third resource, a set of resources associated with a set of fourth resources that conflict with the first resource in spatial domain and overlap with the first resource in time domain. Then the transmitting device 120 may determine the third resource by excluding or deprioritizing the set of resources from the set of candidates. In this way, a beam direction aware sidelink resource selection may be achieved.

With the method 800, beam direction aware sidelink resource selection or reselection may be achieved. Thus, simultaneous PSFCH transmission on multiple antenna panels or beams may be avoided, and fewer PSFCH transmissions may need to be dropped. Thus, link-level and system-level performance may be enhanced.

It is to be noted that the operations of the methods 700 and 800 correspond to that of the process 500 as described above, and thus other details are not repeated here for conciseness.

Example embodiments of the present disclosure also provide the corresponding apparatus. In some embodiments, an apparatus (for example, the transmitting device 110 or 120) capable of performing the method 700 may comprise means for performing the respective steps of the method 700. The means may be implemented in any suitable form. For example, the means may be implemented in a circuitry or software module.

In some embodiments, the apparatus comprises: means for determining, at a first transmitting device, information of a first resource to be used by a receiving device for transmission of a first feedback to the first transmitting device, the first feedback being for a first data transmission from the first transmitting device to the receiving device; and means for transmitting the information of the first resource to a second transmitting device.

In some embodiments, the information of the first resource comprises at least one of the following: time domain information, frequency domain information, or spatial domain information. In some embodiments, the spatial domain information comprises at least one of the following: information of a beam used for the transmission of the first feedback, or information of a panel used for the transmission of the first feedback.

In some embodiments, the first feedback comprises a positive acknowledgement or a negative acknowledgement for the first data transmission.

In some embodiments, the means for transmitting the information of the first resource comprises: means for transmitting the information of the first resource to the second transmitting device in sidelink control information indicating a second resource reserved for the first data transmission.

In some embodiments, an apparatus (for example, the transmitting device 110 or 120) capable of performing the method 800 may comprise means for performing the respective steps of the method 800. The means may be implemented in any suitable form. For example, the means may be implemented in a circuitry or software module.

In some embodiments, the apparatus comprises: means for receiving, at a second transmitting device, information of a first resource to be used by a receiving device for transmission of a first feedback to a first transmitting device, the first feedback being for a first data transmission from the first transmitting device to the receiving device; and means for determining a third resource reserved for a second data transmission from the second transmitting device to the receiving device such that a fourth resource associated with the third resource does not conflict with the first resource, the fourth resource being used by the receiving device for transmission of a second feedback to the second transmitting device, the second feedback being for the second data transmission.

In some embodiments, the information of the first resource comprises at least one of the following: time domain information, frequency domain information, or spatial domain information. In some embodiments, the spatial domain information comprises at least one of the following: information of a beam used for the transmission of the first feedback, or information of a panel used for the transmission of the first feedback.

In some embodiments, the first feedback comprises a positive acknowledgement or a negative acknowledgement for the first data transmission, and the second feedback comprises a positive acknowledgement or a negative acknowledgement for the second data transmission.

In some embodiments, the means for receiving the information of the first resource comprises: means for receiving the information of the first resource in sidelink control information indicating a second resource reserved for the first data transmission.

In some embodiments where the second transmitting device has determined a sixth resource for the second data transmission and a fifth resource for the second feedback is associated with the sixth resource, the means for determining the third resource further comprises: means for, based on reception of the information of the first resource, determining whether the fifth resource conflicts with the first resource; and means for, in accordance with a determination that the fifth resource conflicts with the first resource, reselecting a resource, as the third resource, for the second data transmission.

In some embodiments, the means for determining whether the fifth resource conflicts with the first resource comprises: means for determining whether the fifth resource conflicts with the first resource in spatial domain and overlaps with the first resource in time domain; and means for, in accordance with a determination that the fifth resource conflicts with the first resource in spatial domain and overlaps with the first resource in time domain, determining that the fifth resource conflicts with the first resource.

In some embodiments, the means for determining the third resource comprises: means for determining, from a set of candidates for the third resource, a set of resources associated with a set of fourth resources that conflict with the first resource in spatial domain and overlap with the first resource in time domain; and means for determining the third resource by excluding or deprioritizing the set of resources from the set of candidates.

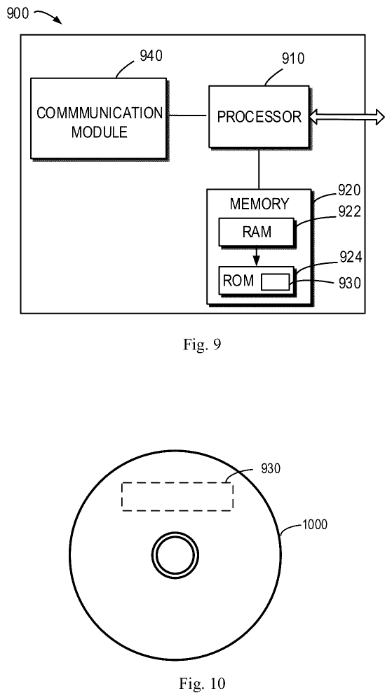

FIG. 9 is a simplified block diagram of a device 900 that is suitable for implementing embodiments of the present disclosure. The device 900 may be provided to implement the communication device, for example the transmitting device 110, the transmitting device 120 or the receiving device 130 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 920. The processor 910 may perform any suitable actions and processing by loading the program 930 into the RAM 920.

The embodiments of the present disclosure may be implemented by means of the program 930 so that the device 900 may perform any process of the disclosure as discussed with reference to FIGS. 1 to 8. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 700 or 800 as described above with reference to FIGS. 7 and 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-25. (canceled)

26. A second transmitting device comprising:
at least one processor; and
at least one memory storing instructions that, when executed by the at least one processor, cause the second transmitting device at least to:
receive information of a first resource to be used by a receiving device for transmission of a first feedback to a first transmitting device, the first feedback being for a first data transmission from the first transmitting device to the receiving device, wherein the information of the first resource is received by: receiving the information of the first resource in sidelink control information indicating a second resource reserved for the first data transmission, wherein the information of the first resource comprises the following: time domain information, frequency domain information, and spatial domain information comprising the following: information of a beam used for the transmission of the first feedback, and information of a panel used for the transmission of the first feedback;
determine a third resource reserved for a second data transmission from the second transmitting device to the receiving device such that a fourth resource associated with the third resource does not conflict with the first resource, the fourth resource being used by the receiving device for transmission of a second feedback to the second transmitting device, the second feedback being for the second data transmission, wherein the third resource is determined by:
determining, from a set of candidates for the third resource, a set of resources associated with a set of fourth resources that conflict with the first resource in spatial domain and overlap with the first resource in time domain; and
determining the third resource from the set of candidates;
determine a sixth resource for the second data transmission and a fifth resource for the second feedback is associated with the sixth resource;
based on determining that the sixth resource for the second data transmission and the fifth resource for the second feedback is associated with the sixth resource and based on reception of the information of the first resource, determining whether the fifth resource conflicts with the first resource by:
determining whether the fifth resource conflicts with the first resource in spatial domain and overlaps with the first resource in time domain; and
in accordance with a determination that the fifth resource conflicts with the first resource in spatial domain and overlaps with the first resource in time domain, determining that the fifth resource conflicts with the first resource; and
based on determining that the fifth resource conflicts with the first resource, reselect a resource, as the third resource, for the second data transmission.

27. The second transmitting device of claim 26, wherein the first feedback comprises a positive acknowledgement for the first data transmission.

28. The second transmitting device of claim 27, wherein the second feedback comprises a positive acknowledgement for the second data transmission.

29. The second transmitting device of claim 27, wherein the second feedback comprises a negative acknowledgement for the second data transmission.

30. The second transmitting device of claim 29, wherein determining the third resource from the set of resources from the set of candidates comprises determining the third resource by excluding the set of resources from the set of candidates.

31. The second transmitting device of claim 29, wherein determining the third resource from the set of resources from the set of candidates comprises determining the third resource by deprioritizing the set of resources from the set of candidates.

32. The second transmitting device of claim 31, wherein the receiving device is a user equipment.

33. A system comprising:
a first transmitting device;
a second transmitting device:
at least one processor; and
at least one memory storing instructions that, when executed by the at least one processor, cause the second transmitting device at least to:
receive information of a first resource to be used by a receiving device for transmission of a first feedback to the first transmitting device, the first feedback being for a first data transmission from the first transmitting device to the receiving device, wherein the information of the first resource is received by: receiving the information of the first resource in sidelink control information indicating a second resource reserved for the first data transmission, wherein the information of the first resource comprises the following: time domain information, frequency domain information, and spatial domain information comprising the following: information of a beam used for the transmission of the first feedback, and information of a panel used for the transmission of the first feedback;
determine a third resource reserved for a second data transmission from the second transmitting device to the receiving device such that a fourth resource associated with the third resource does not conflict with the first resource, the fourth resource being used by the receiving device for transmission of a second feedback to the second transmitting device, the second feedback being for the second data transmission, wherein the third resource is determined by:
determining, from a set of candidates for the third resource, a set of resources associated with a set of fourth resources that conflict with the first resource in spatial domain and overlap with the first resource in time domain; and
determining the third resource from the set of candidates;
determine a sixth resource for the second data transmission and a fifth resource for the second feedback is associated with the sixth resource;
based on determining that the sixth resource for the second data transmission and the fifth resource for the second feedback is associated with the sixth resource and based on reception of the information of the first resource, determining whether the fifth resource conflicts with the first resource by:
determining whether the fifth resource conflicts with the first resource in spatial domain and overlaps with the first resource in time domain; and
in accordance with a determination that the fifth resource conflicts with the first resource in spatial domain and overlaps with the first resource in time domain, determining that the fifth resource conflicts with the first resource; and
based on determining that the fifth resource conflicts with the first resource, reselect a resource, as the third resource, for the second data transmission.

34. The system of claim 33, wherein the first feedback comprises a positive acknowledgement for the first data transmission.

35. The system of claim 34, wherein the second feedback comprises a positive acknowledgement for the second data transmission.

36. The system of claim 34, wherein the second feedback comprises a negative acknowledgement for the second data transmission.

37. The system of claim 36, wherein determining the third resource from the set of resources from the set of candidates comprises determining the third resource by excluding the set of resources from the set of candidates.

38. The system of claim 36, wherein determining the third resource from the set of resources from the set of candidates comprises determining the third resource by deprioritizing the set of resources from the set of candidates.

39. The system of claim 38, wherein the receiving device is a user equipment.

40. A method comprising:
receiving, by a second transmitting device, information of a first resource to be used by a receiving device for transmission of a first feedback to a first transmitting device, the first feedback being for a first data transmission from the first transmitting device to the receiving device, wherein the information of the first resource is received by: receiving the information of the first resource in sidelink control information indicating a second resource reserved for the first data transmission, wherein the information of the first resource comprises the following: time domain information, frequency domain information, and spatial domain information comprising the following: information of a beam used for the transmission of the first feedback, and information of a panel used for the transmission of the first feedback;
determining a third resource reserved for a second data transmission from the second transmitting device to the receiving device such that a fourth resource associated with the third resource does not conflict with the first resource, the fourth resource being used by the receiving device for transmission of a second feedback to the second transmitting device, the second feedback being for the second data transmission, wherein the third resource is determined by:
determining, from a set of candidates for the third resource, a set of resources associated with a set of fourth resources that conflict with the first resource in spatial domain and overlap with the first resource in time domain; and
determining the third resource from the set of candidates;
determining a sixth resource for the second data transmission and a fifth resource for the second feedback is associated with the sixth resource;
based on determining that the sixth resource for the second data transmission and the fifth resource for the second feedback is associated with the sixth resource and based on reception of the information of the first resource, determining whether the fifth resource conflicts with the first resource by:
determining whether the fifth resource conflicts with the first resource in spatial domain and overlaps with the first resource in time domain; and
in accordance with a determination that the fifth resource conflicts with the first resource in spatial domain and overlaps with the first resource in time domain, determining that the fifth resource conflicts with the first resource; and
based on determining that the fifth resource conflicts with the first resource, reselecting a resource, as the third resource, for the second data transmission.

41. The method of claim 40, wherein the first feedback comprises a positive acknowledgement for the first data transmission.

42. The method of claim 41, wherein the second feedback comprises a positive acknowledgement for the second data transmission.

43. The method of claim 41, wherein the second feedback comprises a negative acknowledgement for the second data transmission.

44. The method of claim 43, wherein determining the third resource from the set of resources from the set of candidates comprises determining the third resource by excluding the set of resources from the set of candidates.

45. The method of claim 44, wherein determining the third resource from the set of resources from the set of candidates comprises determining the third resource by deprioritizing the set of resources from the set of candidates.
